(19) United States
(12) Patent Application Publication
(10) Pub. No.: US 2025/0343005 A1
(43) Pub. Date: Nov. 6, 2025

(54) CERAMIC ELECTRONIC COMPONENT AND METHOD FOR MANUFACTURING THE SAME

(71) Applicant: TAIYO YUDEN CO., LTD., Tokyo (JP)

(72) Inventor: Ayumi SHIROTA, Takasaki-shi (JP)

(21) Appl. No.: 19/266,759

(22) Filed: Jul. 11, 2025

Related U.S. Application Data
(63) Continuation of application No. PCT/JP2024/003088, filed on Jan. 31, 2024.

(30) Foreign Application Priority Data
Feb. 1, 2023 (JP) 2023-013912

(51) Int. Cl. H01G 4/30; H01G 4/008; H01G 4/232

(52) U.S. Cl. CPC H01G 4/30; H01G 4/0085; H01G 4/2325

(57) ABSTRACT

A ceramic electronic component includes a multilayer chip including a multilayer body having cover layers provided on a top and a bottom of a multilayer structure in which dielectric layers and internal electrode layers are alternately stacked, and side margins covering two opposing side surfaces of the multilayer body, wherein the internal electrode layers contain a metal component having a melting point of 700° C. or less, the cover layers has a higher Mg concentration than the dielectric layers, at least an outermost internal electrode layer of the internal electrode layers has oxides containing Ni and Mg at both ends in a width direction, and at least some of the internal electrode layers are in contact with voids at both ends in the width direction in a section where internal electrode layers connected to a first external electrode without internal electrode layers connected to a second external electrode interposed therebetween.

### CROSS-REFERENCE TO RELATED APPLICATION

This application is a continuation application of PCT/JP2024/003088, filed on Jan. 31, 2024, which is based upon and claims the benefit of priority of the prior Japanese Patent Application No. 2023-013912, filed on Feb. 1, 2023, the entire contents of which are incorporated herein by reference.

### FIELD

A certain aspect of the present disclosure relates to a ceramic electronic component and a method for manufacturing the same.

### BACKGROUND

In recent years, in the field of electric vehicles and the like, ceramic electronic components such as multilayer ceramic capacitors have been required to have improved high-temperature load life and moisture resistance reliability in addition to miniaturization and high functionality.

### SUMMARY

According to an aspect of the embodiments, there is provided a ceramic electronic component including: a multilayer chip having a substantially rectangular parallelepiped shape, the multiplayer chip including: a multilayer body in which a pair of cover layers are provided on a top and a bottom of a multilayer structure in which dielectric layers and internal electrode layers are alternately stacked, the dielectric layers containing ceramic as a main component, the internal electrode layers containing Ni as a main component, the pair of cover layers containing ceramic as a main component, and a pair of side margins covering two opposing side surfaces of the multilayer body; and a pair of external electrodes provided on a first end surface and a second end surface of the substantially rectangular parallelepiped shape, the first end surface and the second end surface facing each other, the pair of external electrodes each including a plating layer on a base layer, wherein the internal electrode layers are alternately exposed to the first end surface and the second end surface, wherein each of the internal electrode layers contains a metal component having a melting point of 700° C. or less, wherein a Mg concentration of the pair of cover layers is higher than a Mg concentration of the dielectric layers, wherein at least an outermost internal electrode layer of the internal electrode layers has an oxide containing Ni and Mg at both ends in a width direction, and wherein at least some of the internal electrode layers are in contact with voids at both ends in the width direction in a section where internal electrode layers connected to a first external electrode of the pair of external electrodes face each other without internal electrode layers connected to a second external electrode of the pair of external electrodes interposed therebetween.

According to another aspect of the embodiments, there is provided a method for manufacturing a ceramic electronic component, the method including: obtaining a first multilayer body in which multilayer units are stacked, each of the multilayer units including a dielectric green sheet and an internal electrode pattern formed on the dielectric green sheet, the internal electrode pattern containing Ni as a main component, a metal component having a melting point of 700° C. or less being added to the internal electrode pattern; obtaining a second multilayer body in which cover sheets are stacked on a top and a bottom of the first multilayer body in a stacking direction of the multilayer units, respectively, the cover sheets having a Mg concentration higher than a Mg concentration of the dielectric green sheet; obtaining a third multilayer body to which side margin sheets are attached, the side margin sheets covering a first side surface and a second side surface of the second multilayer body, respectively, the internal electrode pattern being exposed to the first side surface and the second side surface; and forming a base layer on each of a first end surface and a second end surface, which face each other, of the third multilayer body when the third multilayer body is fired or after the third multilayer body is fired, the base layer containing a metal as a main component.

### BRIEF DESCRIPTION OF THE DRAWINGS

FIG. 1A is a partial cross-sectional perspective view of a multilayer ceramic capacitor according to a first embodiment, and FIG. 1B is a plan view of the multilayer ceramic capacitor according to the first embodiment;

FIG. 2 is a cross-sectional view taken along line A-A in FIG. 1B;

FIG. 3A is a cross-sectional view taken along line B-B in FIG. 1B, and FIG. 3B is a cross-sectional view taken along line C-C in FIG. 1B;

FIG. 4 is an enlarged cross-sectional view of a section around an external electrode;

FIG. 5A and FIG. 5B are cross-sectional views illustrating an example of a conventional multilayer ceramic capacitor;

FIG. 6 illustrates cracks;

FIG. 7 is a flowchart illustrating a method for manufacturing the multilayer ceramic capacitor according to the first embodiment;

FIG. 8 illustrates an overview of the method for manufacturing the multilayer ceramic capacitor;

FIG. 9A is a partial cross-sectional perspective view of a multilayer ceramic capacitor according to a second embodiment, and FIG. 9B is a cross-sectional view of the multilayer ceramic capacitor according to the second embodiment;

FIG. 10 illustrates an overview of a method for manufacturing the multilayer ceramic capacitor according to the second embodiment;

FIG. 11A and FIG. 11B are partial cross-sectional perspective views of a multilayer ceramic capacitor according to a third embodiment;

FIG. 12 is a cross-sectional view of the multilayer ceramic capacitor according to the third embodiment;

FIG. 13A and FIG. 13B are cross-sectional views of the multilayer ceramic capacitor according to the third embodiment;

FIG. 14 illustrates an overview of a method for manufacturing the multilayer ceramic capacitor according to the third embodiment;

FIG. 15A and FIG. 15B are partial cross-sectional perspective views of a multilayer ceramic capacitor according to a fourth embodiment;

FIG. 16A and FIG. 16B are cross-sectional views of the multilayer ceramic capacitor according to the fourth embodiment; and

FIG. 17 illustrates an overview of a method for manufacturing the multilayer ceramic capacitor according to the fourth embodiment.

### DETAILED DESCRIPTION

In order to improve the high-temperature load life, a multilayer ceramic capacitor has been proposed in which tin (Sn) is added to an internal electrode layer containing nickel (Ni) as a main component, as disclosed in Japanese Patent Application Publication No. 2018-117051 (Patent Document 1). However, when a low-melting-point metal such as Sn is added to the internal electrode layer, a difference between shrinkage behavior of the dielectric layer and shrinkage behavior of the internal electrode layer during firing becomes larger, and thus a void is formed between the end in a width direction of the internal electrode layer and a side margin protecting the end in the width direction of the internal electrode layer, and moisture resistance is deteriorated, as disclosed in Japanese Patent Application Publication No. 2021-034648 (Patent Document 2).

In contrast, it is conceivable to reduce the void by adding magnesium (Mg) to the side margin and oxidizing and expanding the end in the width direction of the internal electrode layer, as disclosed in Japanese Patent Application Publication No. 2009-016796 (Patent Document 3).

In a multilayer ceramic capacitor including internal electrode layers containing Ni as a main component and external electrodes containing Cu as a main component, Cu, which is a main component metal of the external electrodes, diffuses into the internal electrode layers containing Ni as a main component and expands the internal electrode layers when the external electrodes are baked. When the internal electrode layer expands, a crack occurs in a corner portion of the multilayer ceramic capacitor, and moisture resistance reliability is reduced, as disclosed in Japanese Patent Application Publication No. 2014-175034 (Patent Document 4). When a low-melting-point metal such as Sn is added to the internal electrode layer containing Ni as a main component, the amount of diffusion of Cu, which is a main component of the external electrode, increases, and therefore, when Mg is added to the side margin in order to reduce the void, a crack is more likely to occur in the corner portion of the multilayer chip.

Hereinafter, embodiments will be described with reference to the drawings.

### First Embodiment

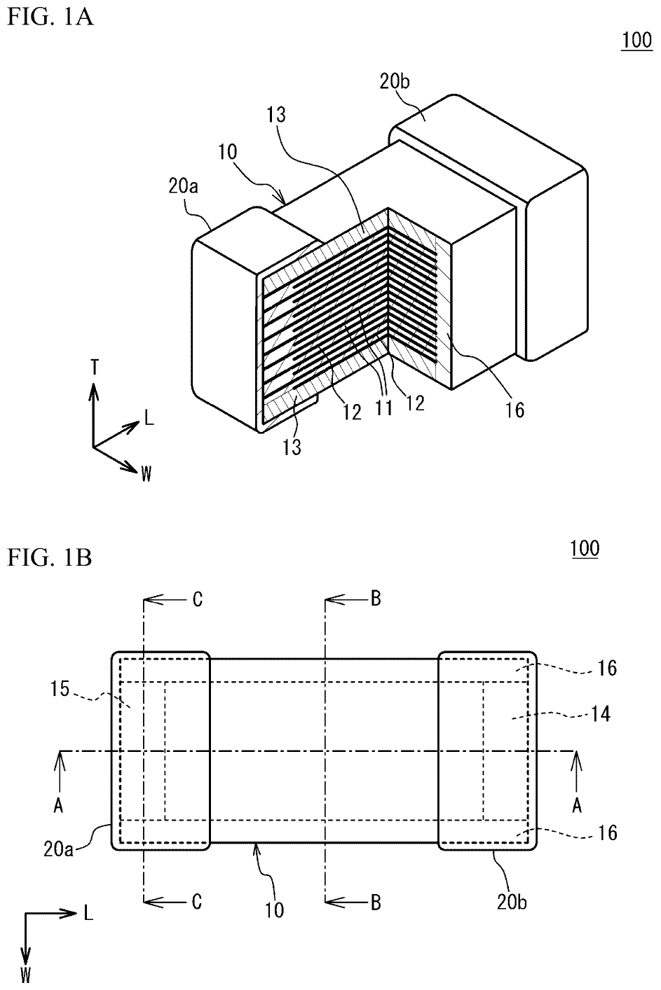

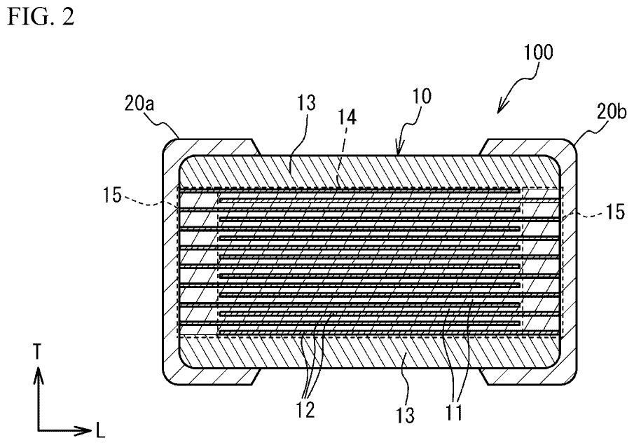

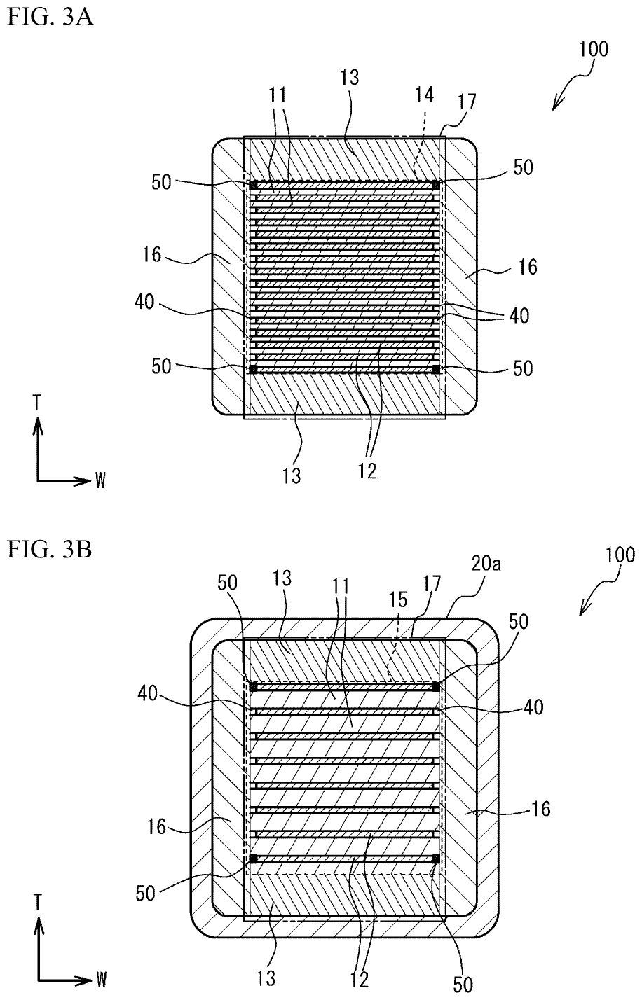

FIG. 1A is a partial cross-sectional perspective view of a multilayer ceramic capacitor 100 according to a first embodiment, and FIG. 1B is a plan view of the multilayer ceramic capacitor 100. FIG. 2 is a cross-sectional view taken along line A-A in FIG. 1B. FIG. 3A is a cross-sectional view taken along line B-B in FIG. 1B, and FIG. 3B is a cross-sectional view taken along line C-C in FIG. 1B, and illustrates a cross section in a section corresponding to an end margin 15 described later.

As illustrated in FIG. 1A, the multilayer ceramic capacitor 100 includes a multilayer chip 10 having a substantially rectangular parallelepiped shape, and external electrodes 20a and 20b provided on two opposing end surfaces of the multilayer chip 10, respectively. Among the four surfaces of the multilayer chip 10 other than the two end surfaces, two surfaces other than the upper surface and the lower surface in the stacking direction are referred to as side surfaces. The external electrodes 20a and 20b extend on the upper surface and the lower surface in the stacking direction and the two side surfaces of the multilayer chip 10. However, the external electrodes 20a and 20b are separated from each other.

In FIG. 1A to FIG. 3B, the L direction is the length direction of the multilayer chip 10, the direction in which the two end surfaces of the multilayer chip 10 face each other, and the direction in which the external electrode 20a and the external electrode 20b face each other. The W direction is a width direction of the internal electrode layers, and is a direction in which two side surfaces of the multilayer chip 10 face each other. The T direction is a stacking direction in which the upper surface and the lower surface of the multilayer chip 10 face each other. The L direction, the W direction, and the T direction are orthogonal to each other.

The multilayer chip 10 includes a multilayer body 17 having a substantially rectangular parallelepiped shape, and side margins 16 provided on both side surfaces of the multilayer body 17 in the W direction (FIG. 3A and FIG. 3B). The multilayer body 17 has a structure in which dielectric layers 11 containing a ceramic material functioning as a dielectric and internal electrode layers 12 containing Ni as a main component are alternately stacked between a pair of cover layers 13.

The edges of the internal electrode layers 12 in the direction in which each internal electrode layer 12 is extended are alternately exposed to a first end surface, on which the external electrode 20a of the multilayer chip 10 is provided, and a second end surface, on which the external electrode 20b is provided. The internal electrode layers 12 connected to the external electrode 20a are not connected to the external electrode 20b. The internal electrode layers 12 connected to the external electrode 20b are not connected to the external electrode 20a. Therefore, the internal electrode layers 12 are alternately electrically connected to the external electrode 20a and the external electrode 20b.

As illustrated in FIG. 2, a section where the internal electrode layers 12 connected to the external electrode 20a and the internal electrode layers 12 connected to the external electrode 20b face each other is a section where an electric capacitance is generated in the multilayer ceramic capacitor 100. Therefore, the section where the electric capacitance is generated is referred to as a capacitance section 14. That is, the capacitance section 14 is a section where the adjacent internal electrode layers 12 connected to different external electrodes face each other.

A section where the internal electrode layers 12 connected to the external electrode 20a face each other without the internal electrode layers 12 connected to the external electrode 20b interposed therebetween is referred to as the end margin 15. A section where the internal electrode layers 12 connected to the external electrode 20b face each other without the internal electrode layers 12 connected to the external electrode 20a interposed therebetween is also the end margin 15. That is, the end margin 15 is a section where the internal electrode layers 12 connected to the same external electrode face each other without the internal electrode layers 12 connected to a different external electrode interposed therebetween. The end margin 15 is a section where no electric capacitance is generated.

As illustrated in FIG. 3A and FIG. 3B, in the multilayer body of the dielectric layers 11 and the internal electrode layers 12, the internal electrode layer 12 is disposed at the uppermost layer in the stacking direction, the internal electrode layer 12 is also disposed at the lowermost layer in the stacking direction, and the upper surface and the lower surface of the multilayer body are covered with the cover layers 13. That is, the pair of cover layers 13 face each other in the stacking direction with the capacitance section 14 and the end margins 15 interposed therebetween. The cover layer 13 is mainly composed of a ceramic material.

Both side surfaces in the W direction of the multilayer body 17 including the multilayer body of the dielectric layers 11 and the internal electrode layers 12 and the pair of cover layers 13 are covered with the side margins 16. That is, the side margin 16 covers the ends in the W direction of the internal electrode layers 12, the dielectric layers 11, and the cover layers 13. The side margin 16 extends from the first end surface to the second end surface of the multilayer chip 10 and extends from the upper surface to the lower surface of the multilayer chip 10. The side margin 16 is mainly composed of a ceramic material. For example, the main component material of the side margin 16 is the same as the main component material of the dielectric layer 11. The side margin 16 is also a section where no capacitance section is generated.

The multilayer ceramic capacitor 100 may have a length of 0.25 mm, a width of 0.125 mm, and a height of 0.125 mm, or a length of 0.4 mm, a width of 0.2 mm, and a height of 0.2 mm, or a length of 0.6 mm, a width of 0.3 mm, and a height of 0.3 mm, or a length of 0.6 mm, a width of 0.3 mm, and a height of 0.110 mm, or a length of 1.0 mm, a width of 0.5 mm, and a height of 0.5 mm, or a length of 1.0 mm, a width of 0.5 mm, and a height of 0.1 mm, or a length of 3.2 mm, a width of 1.6 mm, and a height of 1.6 mm, or a length of 4.5 mm, a width of 3.2 mm, and a height of 0.25 mm. However, the dimensions of the multilayer ceramic capacitor 100 are not limited to the above dimensions.

The internal electrode layer 12 contains nickel (Ni) as a main component. In the present embodiment, in order to increase the electrical barrier at the interface between the dielectric layer 11 and the internal electrode layer 12 and improve the high-temperature load life, a metal component having a melting point lower than 700° C. (hereinafter, referred to as a low-melting-point metal) is added to the internal electrode layer 12. The low-melting-point metal is not particularly limited as long as the melting point is lower than 700° C., and examples thereof include gallium (Ga), indium (In), tin (Sn), bismuth (Bi), lead (Pb), and zinc (Zn). The low-melting-point metal may be alloyed with Ni, which is the main component of the internal electrode layer 12, or may be disposed as a single metal. For example, the low-melting-point metal may be uniformly dispersed in the internal electrode layer 12, or may be segregated at the interface between the internal electrode layer 12 and the dielectric layer 11.

The concentration of the low-melting-point metal in the internal electrode layer 12 is, for example, 1 at %. Here, the concentration of the low-melting-point metal is the amount (at %) of the low-melting-point metal in the whole of one internal electrode layer 12 sandwiched between two adjacent dielectric layers 11, when Ni in the internal electrode layers 12 is defined as 100 at %. When a plurality of types of low-melting-point metals are contained, the concentration of the low-melting-point metal is the total amount of the plurality of types of low-melting-point metals.

To increase the electrical barrier at the interface between the dielectric layer 11 and the internal electrode layer 12 and improving the high-temperature load life, the concentration of the low-melting-point metal in the internal electrode layer 12 is preferably 0.3 at % or greater, and more preferably 0.5 at % or greater. On the other hand, to reduce or prevent excessive shrinkage of the internal electrode layers 12, the concentration of the low-melting-point metal in the internal electrode layer 12 is preferably 5 at % or less, and more preferably 3 at % or less.

The thickness of each internal electrode layer 12 is, for example, 0.1 μm or greater and 2 μm or less. The thickness of each internal electrode layer 12 can be measured by exposing, for example, the cross section of the multilayer ceramic capacitor 100 illustrated in FIG. 2 by mechanical polishing, and then obtaining the average value of thicknesses at 10 locations from an image taken by a microscope such as a scanning transmission electron microscope.

The dielectric layer 11 includes, for example, a ceramic material having a perovskite structure represented by a general formula ABO₃ as a main phase. The perovskite structure includes ABO_{3-α} that has off-stoichiometric composition. For example, the ceramic material may be selected from at least one of the following substances: barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}ZrₓO₃ (0≤x≤1, 0≤y≤1, 0≤z≤1) forming a perovskite structure, and the like. Examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, barium calcium zirconate titanate, or the like.

An additive may be added to the dielectric layer 11. Examples of the additive to the dielectric layer 11 include oxides of magnesium (Mg), manganese (Mn), molybdenum (Mo), vanadium (V), chromium (Cr), or rare earth elements (yttrium (Y), samarium (Sm), curopium (Eu), gadolinium (Gd), terbium (Tb), dysprosium (Dy), holmium (Ho), erbium (Er), thulium (Tm), and ytterbium (Yb)), and oxides containing cobalt (Co), nickel (Ni), lithium (Li), boron (B), sodium (Na), potassium (K), or silicon (Si), and glass containing Co, Ni, Li, B, Na, K, or Si.

The thickness of each dielectric layer 11 is, for example, 0.3 μm or greater and 3 μm or less. The thickness of each dielectric layer 11 can be measured by exposing, for example, the cross section of the multilayer ceramic capacitor 100 illustrated in FIG. 2 by mechanical polishing, and then obtaining the average value of the thicknesses at 10 locations from an image taken with a microscope such as a scanning transmission electron microscope.

The side margin 16 includes, for example, a ceramic material having a perovskite structure represented by the general formula ABO₃ as a main phase. The perovskite structure includes ABO_{3-α} that has an off-stoichiometric composition. For example, the ceramic material may be selected from at least one of the following substances: BaTiO₃, CaZrO₃, CaTiO₃, SrTiO₃, MgTiO₃, Ba_{1-x-y}CaₓSr_{y}Ti_{1-z}Zr_{z}O₃ (0≤x≤1, 0≤y≤1, 0≤z≤1) forming a perovskite structure, and the like. Examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, and barium calcium zirconate titanate.

An additive may be added to the side margin 16. Examples of the additive to the side margin 16 include oxides of Mg, Mn, Mo, V, Cr, or rare earth elements (Y, Sm, Eu, Gd, Tb, Dy, Ho, Er, Tm, or Yb), or oxides containing Co, Ni, Li, B, Na, K, or Si, or glass containing Co, Ni, Li, B, Na, K, or Si.

The cover layer 13 includes, for example, a ceramic material having a perovskite structure represented by the general formula ABO₃ as a main phase. The perovskite structure includes ABO_{3-α} that has an off-stoichiometric composition. For example, the ceramic material may be selected from at least one of the following substances: BaTiO₃, CaZrO₃, CaTiO₃, SrTiO₃, MgTiO₃, Ba_{1-x-y}CaₓSr_{y}Ti_{1-z}Zr_{z}O₃ (0≤x≤1, 0≤y≤1, 0≤z≤1) forming a perovskite structure, and the like. Examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, and barium calcium zirconate titanate.

An additive may be added to the cover layer 13. Examples of the additive to the cover layer 13 include oxides of Mg, Mn, Mo, V, Cr, or rare earth elements (Y, Sm, Eu, Gd, Tb, Dy, Ho, Er, Tm, or Yb), or oxides containing Co, Ni, Li, B, Na, K, or Si, or glass containing Co, Ni, Li, B, Na, K, or Si.

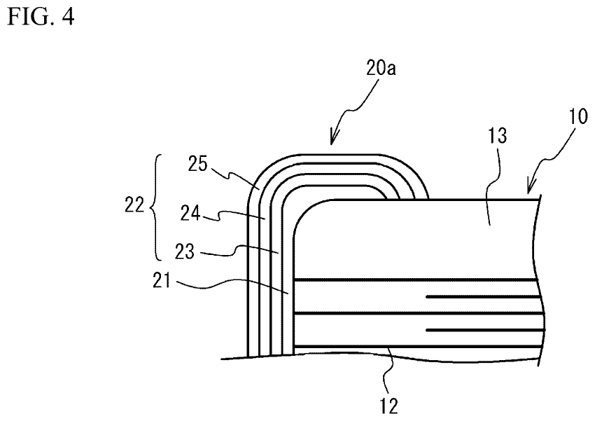

FIG. 4 is an enlarged cross-sectional view of the vicinity of the external electrodes 20a. In FIG. 4, hatching is omitted. As illustrated in FIG. 4, the external electrode 20a has a structure in which a plating layer 22 is provided on a base layer 21, which is a contact layer that is in contact with the first end surface of the multilayer chip 10. The base layer 21 contains Ni, Cu, or the like as a main component. The base layer 21 may contain ceramic particles such as BaTiO₃ as a co-material, and may contain a glass component. The plating layer 22 is mainly composed of a metal such as Cu, Ni, aluminum (Al), zinc (Zn), or Sn, or an alloy of two or more of these metals. The plating layer 22 may be a plating layer of a single metal component, or may be a plurality of plating layers of different metal components. For example, the plating layer 22 has a structure in which a first plating layer 23, a second plating layer 24, and a third plating layer 25 are formed in this order from the base layer 21 side. The first plating layer 23 is, for example, a Cu plating layer. The second plating layer 24 is, for example, a Ni plating layer. The third plating layer 25 is, for example, a Sn plating layer. Although FIG. 4 illustrates the external electrode 20a, the external electrode 20b also has the same multilayer structure.

Here, a problem that occurs when a low-melting-point metal is added to the internal electrode layer 12 in order to improve the high-temperature load life will be described.

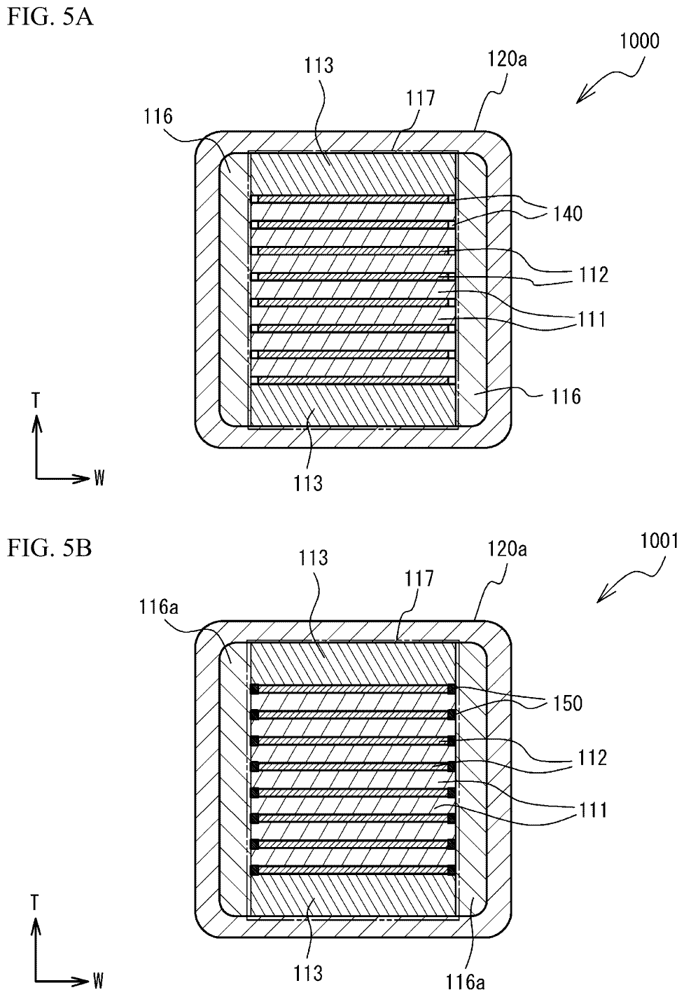

FIG. 5A is a cross-sectional view illustrating an example of a conventional multilayer ceramic capacitor 1000, and illustrates a cross section at the same position as in FIG. 3B. In the multilayer ceramic capacitor 1000, internal electrode layers 112 contain Ni as a main component, and a low-melting-point metal. Dielectric layers 111, cover layers 113, and side margins 116 include a ceramic material having a perovskite structure represented by a general formula ABO₃ as a main phase, and have substantially the same composition.

The multilayer ceramic capacitor 1000 includes a multilayer body 117 including the dielectric layers 111, the internal electrode layers 112, and the cover layers 113, and the side margins 116 covering both end surfaces of the multilayer body 117 in the W direction.

In this case, when the internal electrode layers 112 contain a low-melting-point metal, the difference between the shrinkage behavior of the dielectric layer 111 and the shrinkage behavior of the internal electrode layer 112 becomes larger during firing. As a result, as illustrated in FIG. 5A, voids 140 are formed between the ends in the W direction of the internal electrode layers 112 and the side margins 116, and the moisture resistance is reduced. The void 140 refers to a void having a dimension in the W direction or the T direction equal to or larger than the average thickness of the internal electrode layer 112.

FIG. 5B is a cross-sectional view illustrating a conventional multilayer ceramic capacitor 1001, and illustrates a cross section at the same position as in FIG. 3B. In the multilayer ceramic capacitor 1001, the internal electrode layer 112 contains Ni as a main component, and a low-melting-point metal. The dielectric layers 111, the cover layers 113, and side margins 116a include a ceramic material having a perovskite structure represented by the general formula ABO₃ as a main phase, but the Mg concentration in the side margin 116a is higher than those in the dielectric layer 111 and the cover layer 113.

In the multilayer ceramic capacitor 1001 illustrated in FIG. 5B, oxides 150 containing Ni and Mg are formed at both ends in the W direction of the internal electrode layer 112 during firing, and both ends in the W direction of the internal electrode layer 112 expand, so that the voids are reduced or prevented. This can reduce or prevent a decrease in moisture resistance.

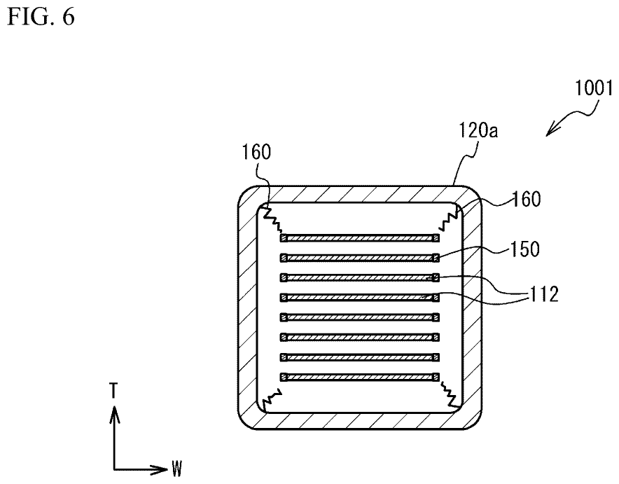

On the other hand, when the internal electrode layer 112 and an external electrode 120a react with each other in baking the external electrode 120a, the metal component of the external electrode 120a diffuses to the Ni side of the internal electrode layer 112, and the internal electrode layer 112 expands. For example, when the main component metal of the base layer of the external electrode 20a and the main component metal of the internal electrode layer 112 are different, the diffusion is likely to occur. In particular, the diffusion is likely to occur when the main component metal of the base layer is Cu and the main component metal of the internal electrode layer 112 is Ni. The expansion of the internal electrode layer 112 causes stresses directed outward in the cover layer 113 and the side margin 116a, and cracks are generated. When a low-melting-point metal such as Sn is added to the internal electrode layer 112, diffusion from the external electrode 120a is facilitated, and when the external electrode 120a is baked, cracks 160 as illustrated in FIG. 6 may occur in the portions (corner portions in the vicinity of the external electrode) covered with the external electrode 120a, where the cover layer 113 and the side margin 116a overlap each other.

Therefore, the multilayer ceramic capacitor 100 according to the present embodiment has a configuration that improves the high-temperature load life and that is able to reduce or prevent a decrease in moisture resistance due to the voids formed between the both ends in the W direction of the internal electrode layers 12 and the side margins 16 and a decrease in moisture resistance due to the occurrence of cracks.

Specifically, the cover layer 13 has a higher Mg concentration than the dielectric layer 11 and the side margin 16. Therefore, as illustrated in FIG. 3A, in the section corresponding to the capacitance section 14, the outermost internal electrode layers 12 in the stacking direction have oxides 50 containing Ni and Mg at both ends in the W direction, and thus voids 40 between both ends in the W direction of the outermost internal electrode layers 12 and the side margins 16 are reduced or prevented. Therefore, it is possible to reduce or prevent a decrease in moisture resistance in the portion of the multilayer chip 10 not covered with the external electrode 20a or 20b.

As illustrated in FIG. 3B, in the end margin 15, the outermost internal electrode layer 12 of the internal electrode layers 12 connected to the external electrode 20a has the oxides 50 containing Ni and Mg at both ends in the W direction. Among the internal electrode layers 12 connected to the external electrodes 20a, the lowermost internal electrode layer 12 is not in contact with the cover layer 13 having a high Mg concentration, but the distance between the lowermost internal electrode layer 12 and the cover layer 13 is short, and the internal electrode layer 12 connected to the external electrode 20b is not present. Therefore, the oxides 50 containing Ni and Mg are formed also at both ends in the W direction of the lowermost internal electrode layer 12 due to the effect of Mg added to the cover layer 13. The same applies to the uppermost internal electrode layer 12 of the internal electrode layers 12 connected to the external electrode 20b. This can reduce or prevent a decrease in moisture resistance in the end margin 15.

As illustrated in FIG. 3B, both ends in the W direction of the internal electrode layers 12 other than the uppermost and lowermost internal electrode layers 12 among the internal electrode layers 12 connected to the external electrode 20a do not have oxides containing Ni and Mg, and are in contact with the voids 40 formed between the side margins 16 and the internal electrode layers 12, respectively. Therefore, even when the internal electrode layers 12 expand due to the diffusion of the main component metal of the base layer 21 of the external electrode 20a and outward stresses are generated in the cover layers 13 and the side margins 16, the stresses can be relaxed by the voids 40, and thus the occurrence of cracks can be reduced or prevented. This can reduce or prevent a decrease in moisture resistance due to the occurrence of cracks.

The Mg concentration in the cover layer 13 is, for example, 1.5 at % or greater. Here, the Mg concentration in the cover layer 13 is the amount (at %) of Mg when the B-site element of the cover layer 13 is defined as 100 at % in the entire cover layer 13.

In order to facilitate oxidation of Ni, which is the main component metal of the internal electrode layers 12, and to sufficiently oxidize and expand both ends in the W direction of the outermost internal electrode layers 12, the Mg concentration in the cover layers 13 is preferably 2.0 at % or greater. On the other hand, to reduce or prevent a decrease in dielectric constant due to excessive diffusion of Mg into the dielectric layer 11, the Mg concentration in the cover layer 13 is preferably 5 at % or less, and more preferably 2.5 at % or less.

To prevent a decrease in dielectric constant, the Mg concentrations in the dielectric layer 11 and the side margin 16 are preferably 0.5 at % or less, and more preferably 0.25 at % or less. The Mg concentration in the dielectric layer 11 is the amount (at %) of Mg when the B-site element of the dielectric layer 11 is defined as 100 at % in the whole of the dielectric layer 11 sandwiched between two adjacent internal electrode layers 12. In addition, the Mg concentration in the side margin 16 is the amount (at %) of Mg when the B-site element of the side margin 16 is defined as 100 at % in the entire side margin 16.

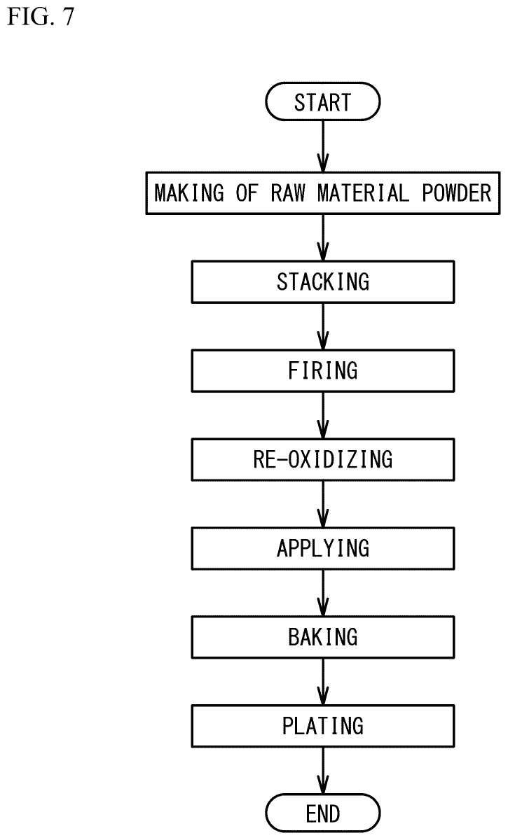

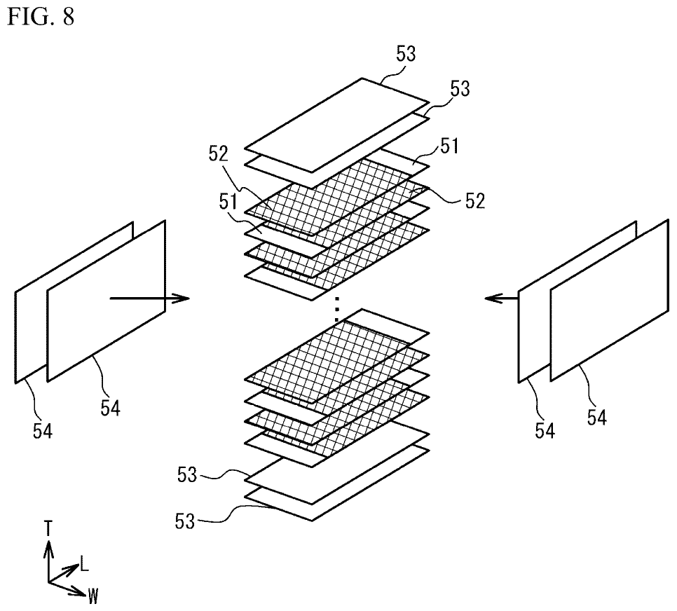

Next, a method for manufacturing the multilayer ceramic capacitor 100 according to the first embodiment will be described. FIG. 7 is a flowchart illustrating a method for manufacturing the multilayer ceramic capacitor 100. FIG. 8 illustrates an overview of the method for manufacturing the multilayer ceramic capacitor 100.

### Making of Raw Material Powder

First, a dielectric material for forming the dielectric layer 11 is prepared. The A-site element and the B-site element contained in the dielectric layer 11 are usually contained in the dielectric layer 11 in the form of a sintered body of ABO₃ particles. For example, BaTiO₃ is a tetragonal compound having a perovskite structure and exhibits a high dielectric constant. In general, BaTiO₃ can be obtained by reacting a titanium raw material such as titanium dioxide with a barium raw material such as barium carbonate to synthesize barium titanate. As a method of synthesizing the main component ceramic of the dielectric layer 11, various methods have been known, and for example, a solid phase method, a sol-gel method, a hydrothermal method, and the like are known. In the present embodiment, any of these can be adopted.

A predetermined additive compound is added to the obtained ceramic powder depending on the purpose. Examples of the additive compound include oxides of Mg, Mn, Mo, V, Cr, or rare earth elements (Y, Sm, Eu, Gd, Tb, Dy, Ho, Er, Tm, and Yb), and oxides containing Co, Ni, Li, B, Na, K, or Si, and glasses containing Co, Ni, Li, B, Na, K, or Si. Among these, SiO₂ mainly functions as a sintering aid.

For example, a compound containing an additive compound is wet-mixed with a ceramic raw material powder, and the mixture is dried and pulverized to prepare a ceramic material. For example, the particle size of the ceramic material is adjusted by performing a pulverization treatment on the ceramic material obtained as described above, or may be adjusted by combination of the pulverization treatment and a classification treatment, as necessary. The dielectric material is obtained by the above steps. To prevent a decrease in dielectric constant, the Mg concentration in the dielectric material is preferably 0.5 at % or less, and more preferably 0.25 at % or less. The Mg concentration in the dielectric material is the amount (at %) of Mg when the B-site element in the dielectric material is defined as 100 at %.

Then, a margin material for forming the side margin 16 is prepared. The margin material contains the main component ceramic of the side margin 16. As the main component ceramic, for example, BaTiO₃ powder is prepared. The BaTiO₃ powder can be prepared by the same procedure as that for the dielectric material. A predetermined additive compound is added to the resulting BaTiO₃ powder according to the purpose. Examples of the additive compound include oxides of Zr, Ca, Sr, Mg, Mn, V, Cr, or rare earth elements, and oxides of Co, Ni, Li, B, Na, K, or Si, and glass. In the case where Mg is added to the margin material, to prevent a decrease in dielectric constant, the Mg concentration in the margin material is preferably 0.5 at % or less, and more preferably 0.25 at % or less when the concentration of the B-site element is defined as 100 at %. The Mg concentration in the margin material is the amount (at %) of Mg when the B-site element in the margin material is defined as 100 at %.

Then, a cover material for forming the cover layer 13 is prepared. The cover material contains the main component ceramic of the cover layer 13. As the main component ceramic, for example, BaTiO₃ powder is prepared. The BaTiO₃ powder can be prepared by the same procedure as that for the dielectric material. Mg is added to the resulting BaTiO₃ powder. In addition to Mg, other additive compounds may be added. Examples of other additive compounds include oxides of Zr, Ca, Sr, Mn, V, Cr, or rare earth elements, and oxides of Co, Ni, Li, B, Na, K, or Si, and glass. The Mg concentration in the cover material is adjusted to be higher than the Mg concentration in the dielectric material and the Mg concentration in the margin material.

The Mg concentration in the cover material is, for example, 1.5 at % or greater. The Mg concentration in the cover material is the amount (at %) of Mg when the B-site element in the cover material is defined as 100 at %.

To facilitate oxidation of Ni, which is the main component metal of the internal electrode layers 12, and sufficiently oxidize and expand both ends in the W direction of the outermost internal electrode layers 12, the Mg concentration in the cover material is preferably 2.0 at % or greater. On the other hand, to reduce or prevent a decrease in dielectric constant due to excessive diffusion of Mg into the dielectric layer 11, the Mg concentration in the cover material is preferably 5 at % or less, and more preferably 2.5 at % or less.

### Stacking

Then, a binder such as polyvinyl butyral (PVB) resin, an organic solvent such as ethanol or toluene, and a plasticizer are added to the dielectric material obtained in the making of the raw material powder, and wet-mixed. The resulting slurry is applied onto a base material by, for example, a die coater method or a doctor blade method, and dried to obtain a dielectric green sheet 51. The base material is, for example, a polyethylene terephthalate (PET) film.

Then, as illustrated in FIG. 8, an internal electrode pattern 52 is formed on the dielectric green sheet 51. The dielectric green sheet 51 on which the internal electrode pattern 52 is formed is handled as a multilayer unit. The width of the internal electrode pattern 52 in the W direction is made to be equal to the width of the dielectric green sheet 51 in the W direction. In FIG. 8, the internal electrode pattern 52 is indicated by hatching.

For the internal electrode pattern 52, used is a metal paste containing Ni, which is the main component metal of the internal electrode layer 12, and to which a low-melting-point metal having a melting point of 700° C. or less is added. The concentration of the low-melting-point metal in the metal paste is, for example, 1 at %. The concentration of the low-melting-point metal in the metal paste is the amount (at %) of the low-melting-point metal when Ni in the metal paste is defined as 100 at %. When a plurality of types of low-melting-point metals are contained, the addition concentration of the low-melting-point metal is the total amount of the plurality of types of low-melting-point metals.

To increase the electrical barrier at the interface between the dielectric layer 11 and the internal electrode layer 12, the concentration of the low-melting-point metal in the metal paste is preferably 0.3 at % or greater, and more preferably 0.5 at % or greater. On the other hand, to reduce or prevent excessive shrinkage of the internal electrode layer 12, the concentration of the low-melting-point metal in the metal paste is preferably 5 at % or less, and more preferably 3 at % or less. The method of film formation may be printing, sputtering, vapor deposition, or the like.

Then, while the dielectric green sheet 51 is peeled off from the base material, the multilayer units are stacked as illustrated in FIG. 8.

Then, a binder such as polyvinyl butyral (PVB) resin, an organic solvent such as ethanol or toluene, and a plasticizer are added to the cover material obtained in the making of the raw material powder, and wet-mixed. The resulting slurry is applied onto a base material by, for example, a die coater method or a doctor blade method, and dried to obtain a strip-shaped cover sheet 53 having a thickness of, for example, 10 μm or less. The width of the cover sheet 53 in the W direction is made to be equal to the width of the dielectric green sheet 51 in the W direction.

As illustrated in FIG. 8, a predetermined number (for example, 2 to 10) of cover sheets 53 are stacked on the top and the bottom of the multilayer body obtained by stacking the multilayer units, and are bonded by thermal compression.

Then, a binder such as polyvinyl butyral (PVB) resin, an organic solvent such as ethanol or toluene, and a plasticizer are added to the margin material obtained in the making of the raw material powder, and wet-mixed. The resulting slurry is applied onto a base material by, for example, a die coater method or a doctor blade method and dried to obtain a strip-shaped side margin sheet 54 having a thickness of, for example, 10 μm or less.

Then, a plurality of the side margin sheets 54 are attached to each of two side surfaces of the multilayer body by stacking the cover sheets 53 and the multilayer units.

### Firing

Thereafter, the resultant is fired at 1100° C. to 1300° C. for 10 minutes to 2 hours in a reducing atmosphere with an oxygen partial pressure of 10⁻⁵ to 10⁻⁸ atm.

### Re-Oxidizing

Thereafter, re-oxidation treatment may be performed at 600° C. to 1000° C. in an N₂ gas atmosphere.

### Applying

Then, a metal paste containing a metal such as Cu or Ni as a main component, which is to be the base layer 21, is applied to a first side surface of the multilayer body by dipping or the like. The metal paste contains a glass component such as glass frit.

### Baking

Then, the metal paste is baked at a temperature of about 700° C. to 900° C. to form the base layer 21.

### Plating

Thereafter, the base layer 21 may be coated with a metal such as Cu, Ni, Sn, or the like by plating. For example, the first plating layer 23, the second plating layer 24, and the third plating layer 25 are formed in this order on the base layer 21. This completes the multilayer ceramic capacitor 100.

According to the manufacturing method of the present embodiment, since Mg is added to the cover material that becomes the cover layer 13, oxides containing Ni and Mg is formed at the ends in the W direction of the outermost internal electrode layers 12 in the firing step, and the ends in the W direction of the internal electrode layers 12 expand. This can inhibit voids from being formed between the ends of the outermost internal electrode layer 12 in the W direction and the side margins 16, and can inhibit the moisture resistance from being lowered. In addition, the oxides containing Ni and Mg are not formed at the ends in the W direction of the internal electrode layers 12 other than the outermost internal electrode layers 12, and the voids 40 are formed. As a result, even when outward stresses are generated in the cover layers 13 and the side margins 16 due to the expansion of the internal electrode layers 12 caused by the diffusion of the main component metals of the external electrodes 20a and 20b, the stress can be relieved by the voids 40 and occurrence of cracks can be reduced or prevented. In addition, for the internal electrode pattern 52, a metal paste containing Ni, which is the main component metal of the internal electrode layer 12, and to which a low-melting-point metal is added is used, and therefore, the electrical barrier at the interface between the dielectric layer 11 and the internal electrode layer 12 can be increased, and the high-temperature load life can be improved.

### Second Embodiment

In the above first embodiment, the outermost internal electrode layers 12 have oxides containing Ni and Mg at the both ends in the W direction, but a predetermined number of the internal electrode layers 12 including the outermost internal electrode layers 12 may have oxides of Ni and Mg at both ends in the W direction. That is, one or more internal electrode layers 12 from the outermost layer may have oxides of Ni and Mg at both ends in the W direction.

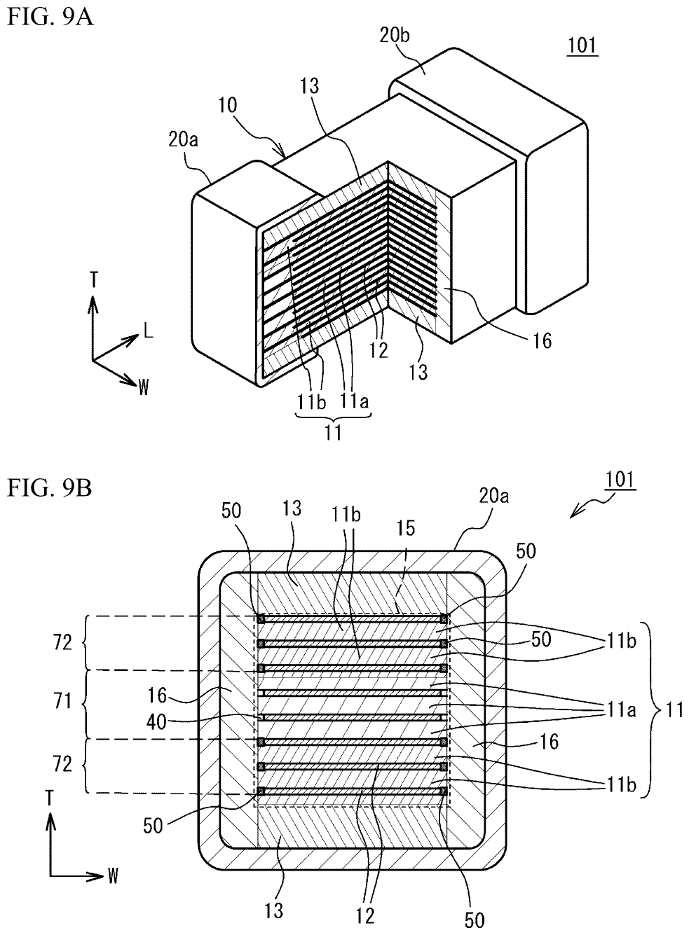

FIG. 9A is a partial cross-sectional perspective view of a multilayer ceramic capacitor 101 according to a second embodiment, and FIG. 9B is a cross-sectional view of the multilayer ceramic capacitor 101. FIG. 9B illustrates a cross section at the same position as that in FIG. 3B.

As illustrated in FIG. 9B, in the multilayer ceramic capacitor 101 according to the second embodiment, the dielectric layers 11 include an inner dielectric layer 11a and an outer dielectric layer 11b. The outer dielectric layer 11b is one or more dielectric layers 11 from the outermost layer among the dielectric layers 11, and is located further outward than the inner dielectric layers 11a in the stacking direction (T direction). The section where the inner dielectric layers 11a and the internal electrode layers 12 are stacked is defined as an inner section 71, and the section where the outer dielectric layers 11b and the internal electrode layers 12 are stacked is defined as an outer section 72.

The main phases of the inner dielectric layer 11a and the outer dielectric layer 11b are the same as those of the dielectric layer 11 according to the first embodiment, but the Mg concentration of the outer dielectric layer 11b is higher than the Mg concentration of the inner dielectric layer 11a. In addition, the Mg concentration of the outer dielectric layer 11b is higher than the Mg concentration of the side margin 16. The Mg concentration of the outer dielectric layer 11b may be the same as or different from the Mg concentration of the cover layer 13 as long as the Mg concentration of the outer dielectric layer 11b is higher than the Mg concentration of the inner dielectric layer 11a and the Mg concentration of the side margin 16.

The Mg concentration in the outer dielectric layer 11b is, for example, 1.5 at % or greater. To facilitate the oxidation of Ni, which is the main component metal of the internal electrode layers 12, and sufficiently oxidize and expand both ends in the W direction of the internal electrode layers 12 in contact with the outer dielectric layer 11b, the Mg concentration in the outer dielectric layer 11b is preferably 2.0 at % or greater. On the other hand, to reduce or prevent a decrease in dielectric constant due to excessive diffusion of Mg into the inner dielectric layer 11a, the Mg concentration in the outer dielectric layer 11b is preferably 5 at % or less, and more preferably 2.5 at % or less.

The number of the stacked outer dielectric layers 11b having a higher Mg concentration in each of the outer sections 72 is preferably about 5% or greater of the total number of stacked layers to improve the moisture resistance of the corner portion, and is preferably about 20% or less of the total number of stacked layers to reduce or prevent cracks in the corner portion due to expansion of the internal electrode layers 12.

Other configurations are the same as those of the first embodiment, and thus the detailed description thereof will be omitted.

Since the Mg concentration of the outer dielectric layer 11b is higher than the Mg concentration of the inner dielectric layer 11a and the Mg concentration of the side margin 16, the internal electrode layer 12 in contact with the outer dielectric layer 11b has the oxides 50 containing Ni and Mg at both ends in the W direction. This can reduce or prevent the voids 40 between the side margins 16 and each end in the W direction of the internal electrode layers 12, and thus can improve the moisture resistance. In addition, the voids 40 are formed between both ends in the W direction of the internal electrode layers 12 included in the inner section 71 and the side margins 16. Therefore, even when outward stresses are generated in the cover layers 13 and the side margins 16 due to the expansion of the internal electrode layers 12 caused by the diffusion of the main component metals of the external electrodes 20a and 20b, the stresses can be relieved by the voids 40, and the occurrence of cracks can be reduced or prevented.

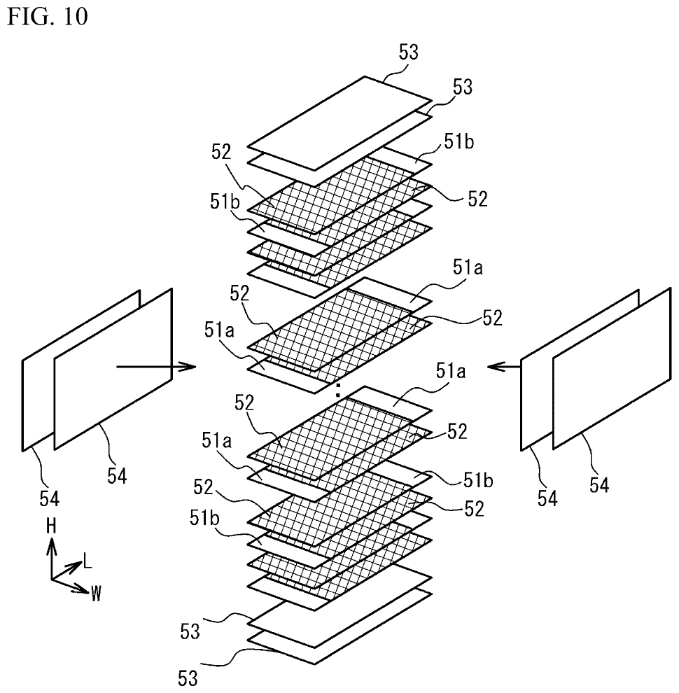

FIG. 10 illustrates an overview of a method for manufacturing the multilayer ceramic capacitor 101 according to the second embodiment. When the multilayer ceramic capacitor 101 is manufactured, for example, as illustrated in FIG. 10, the Mg concentration in a second dielectric green sheet 51b corresponding to the outer dielectric layer 11b is adjusted to be higher than the Mg concentration in a first dielectric green sheet 51a corresponding to the inner dielectric layer 11a. The Mg concentration in the second dielectric green sheet 51b is, for example, 1.5 at % or greater. The Mg concentration in the second dielectric green sheet 51b is the amount (at %) of Mg in the entire second dielectric green sheet 51b when the B-site element in the second dielectric green sheet 51b is defined as 100 at %.

To facilitate the oxidation of Ni, which is the main component metal of the internal electrode layers 12, and sufficiently oxidize and expand both ends in the W direction of the internal electrode layers 12 in contact with the second dielectric green sheet 51b, the Mg concentration of the second dielectric green sheet 51b is preferably 2.0 at % or greater. On the other hand, to reduce or prevent a decrease in dielectric constant due to excessive diffusion of Mg to the inner dielectric layer 11a, the Mg concentration of the second dielectric green sheet 51b is preferably 5 at % or less, and more preferably 2.5 at % or less.

### Third Embodiment

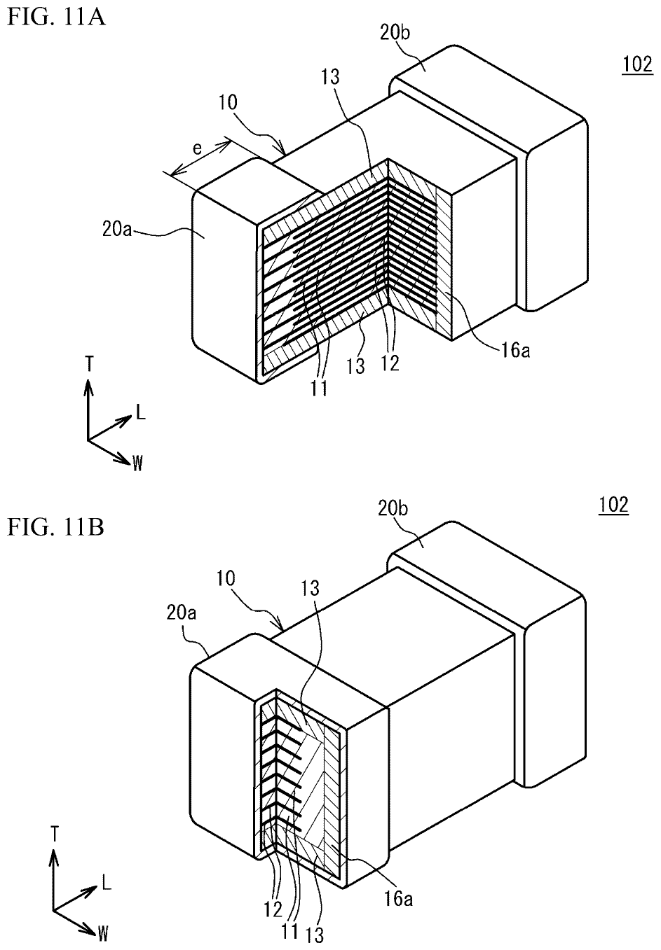

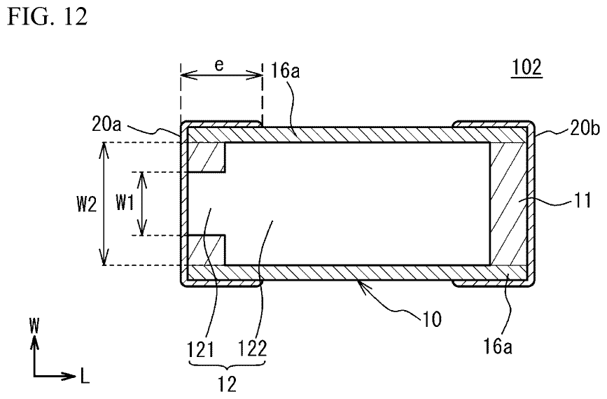

In a multilayer ceramic capacitor 102 according to a third embodiment, the width of the internal electrode layer 12 is varied. FIG. 11A and FIG. 11B are partial cross-sectional perspective views of the multilayer ceramic capacitor 102 according to the third embodiment. FIG. 12 is a cross-sectional view of the multilayer ceramic capacitor 102.

As illustrated in FIG. 12, the internal electrode layers 12 connected to the external electrode 20a include a first section 121 (connection portion) that has a width W1 and is connected to the external electrode 20a in the section corresponding to the end margin 15, and a second section 122 having a width W2 in the section corresponding to the capacitance section 14. The width W1 is smaller than the width W2. The widths W1 and W2 are widths in the W direction. In this configuration, the contact area between the external electrode 20a and the internal electrode layers 12 and the contact area between the external electrode 20b and the internal electrode layers 12 are reduced, and thus the diffusion from the external electrodes 20a and 20b to the internal electrode layers 12 is reduced or prevented. This reduces or prevents the occurrence of cracks. The internal electrode layers 12 connected to the external electrode 20b also include the first section 121 having the width W1 and the second section 122 having the width W2.

For example, if the ratio W1/W2 is small, the connectivity between the external electrode 20a and the internal electrode layers 12 and between the external electrode 20b and the internal electrode layers 12 may decrease, and good conduction may not be obtained, and therefore, it is preferable to set a lower limit for the ratio W1/W2. On the other hand, if the ratio W1/W2 is large, the contact area between the external electrode 20a and the internal electrode layers 12 and the contact area between the external electrode 20b and the internal electrode layers 12 cannot be sufficiently reduced. Therefore, it is preferable to set an upper limit for W1/W2. Based on the above, W1/W2 is preferably 1/2 or greater, and more preferably 2/3 or greater. The ratio W1/W2 is preferably 4/5 or less, and more preferably 3/4 or less.

Here, as illustrated in FIG. 11A and FIG. 12, the dimension in which the external electrodes 20a and 20b extend in the L direction from respective end surfaces of the multilayer chip 10 is referred to as a dimension e. To reduce or prevent the occurrence of cracks in the corner portion, the dimension of the first section 121 in the L direction is preferably equal to or greater than 1/3 of the dimension e, and more preferably equal to or greater than 1/2 of the dimension c.

In the third embodiment, the Mg concentration of a side margin 16a is higher than that of the dielectric layer 11. Therefore, in the third embodiment, the Mg concentration of the cover layer 13 and the Mg concentration of the side margin 16a are higher than the Mg concentration of the dielectric layer 11. The Mg concentration of the cover layer 13 and the Mg concentration of the side margin 16a may be equal to or different from each other.

The Mg concentration of the side margin 16a is, for example, 1.5 at % or greater. To facilitate the oxidation of Ni, which is the main component metal of the internal electrode layers 12, and sufficiently oxidize and expand both ends in the W direction of the internal electrode layers 12 in contact with the side margins 16a, the Mg concentration of the side margin 16a is preferably 2.0 at % or greater. On the other hand, to reduce or prevent a decrease in dielectric constant due to excessive diffusion of Mg into the dielectric layer 11, the Mg concentration of the side margin 16a is preferably 5 at % or less, and more preferably 2.5 at % or less.

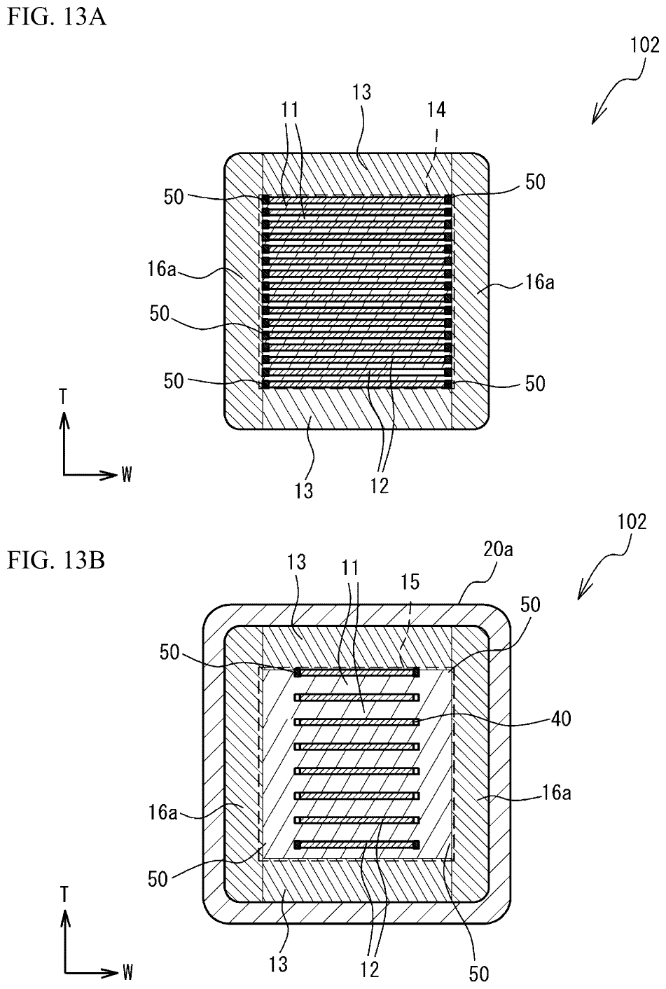

FIG. 13A and FIG. 13B are cross-sectional views of the multilayer ceramic capacitor 102. The cross section of FIG. 13A is a cross section at the same position as that of FIG. 3A, and the cross section of FIG. 13B is a cross section at the same position as that of FIG. 3B.

Since the Mg concentration of the side margin 16a is higher than the Mg concentration of the dielectric layer 11, as illustrated in FIG. 13A, the internal electrode layers 12 in the section corresponding to the capacitance section 14 have the oxides 50 containing Ni and Mg at both ends in the W direction. This can reduce or prevent the formation of voids between both ends in the W direction of the internal electrode layers 12 and the side margins 16a in the section corresponding to the capacitance section 14, and thus the moisture resistance is improved.

On the other hand, as illustrated in FIG. 13B, in the end margins 15, the uppermost and lowermost internal electrode layers 12 among the internal electrode layers 12 connected to the external electrode 20a have the oxides 50 containing Ni and Mg at the ends in the W direction because of Mg of the cover layers 13. The voids 40 are formed between the ends in the W direction of other internal electrode layers 12 and the dielectric layers 11. This improves the moisture resistance, and even when outward stresses are generated in the cover layers 13 and the side margins 16 due to the expansion of the internal electrode layers 12 caused by the diffusion of Cu, which is the main component metal of the external electrodes 20a and 20b, the stresses can be relaxed by the voids 40, and the occurrence of cracks can be reduced or prevented.

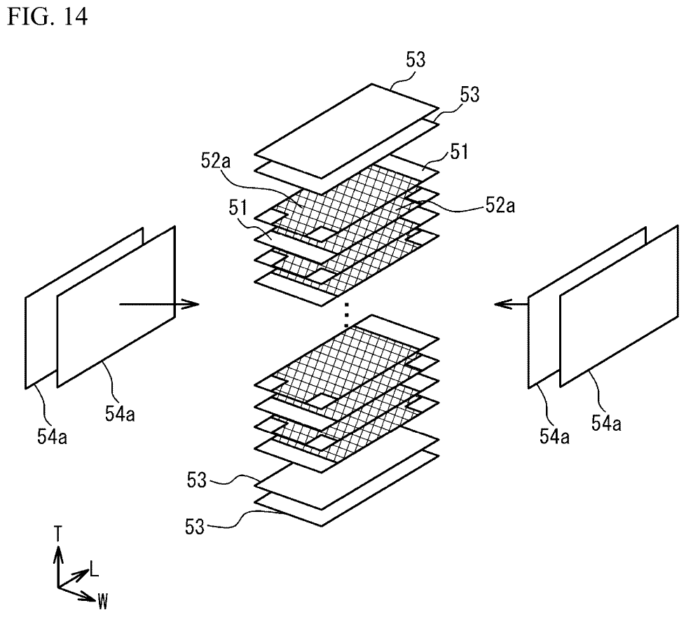

FIG. 14 illustrates an overview of a method for manufacturing the multilayer ceramic capacitor 102 according to the third embodiment. In the case of manufacturing the multilayer ceramic capacitor 102, as illustrated in FIG. 14, the multilayer ceramic capacitor 101 can be manufactured by stacking the dielectric green sheets 51 on which internal electrode patterns 52a having the widths W1 and W2 are respectively formed, and attaching side margin sheets 54a having a higher Mg concentration than the dielectric green sheet 51 to both side surfaces in the W direction of the multilayer body.

The Mg concentration of the side margin sheet 54a is, for example, 1.5 at % or greater. The Mg concentration of the side margin sheet 54a is the amount (at %) of Mg when the B-site element of the side margin sheet 54a is defined as 100 at % in the entire side margin sheet 54a.

To facilitate the oxidation of Ni, which is the main component metal of the internal electrode layers 12, and sufficiently oxidize and expand both ends in the W direction of the internal electrode layers 12 in contact with the side margin sheet 54a, the Mg concentration of the side margin sheet 54a is preferably 2.0 at % or greater. On the other hand, to reduce or prevent a decrease in dielectric constant due to excessive diffusion of Mg into the dielectric layer 11, the Mg concentration in the side margin sheet 54a is preferably 5 at % or less, and more preferably 2.5 at % or less.

### Fourth Embodiment

In the third embodiment, all the internal electrode layers 12 have the first section 121 and the second section 122, but some of the internal electrode layers 12 may have the first section 121 and the second section 122.

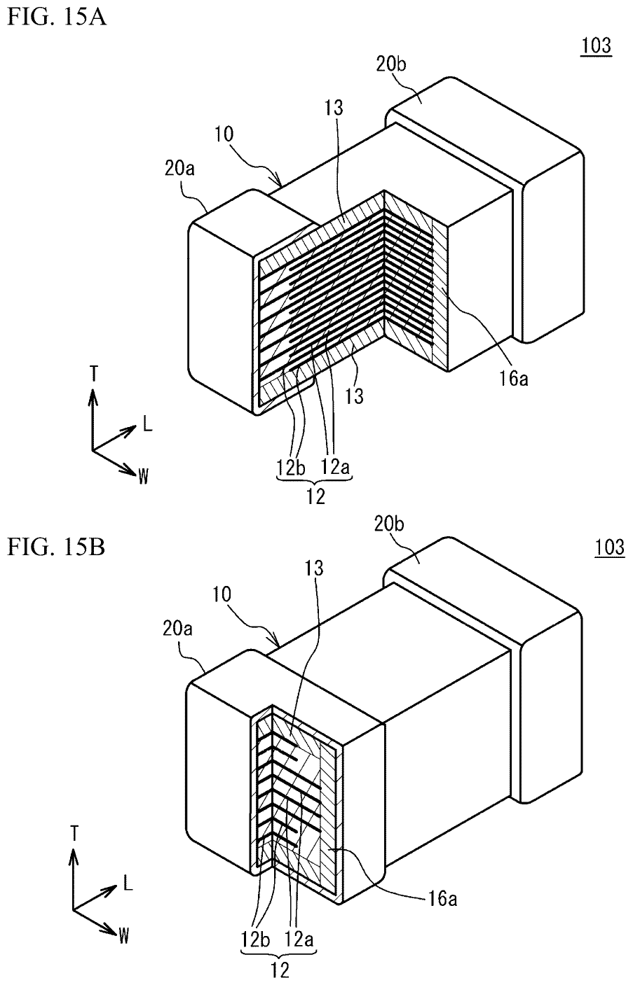

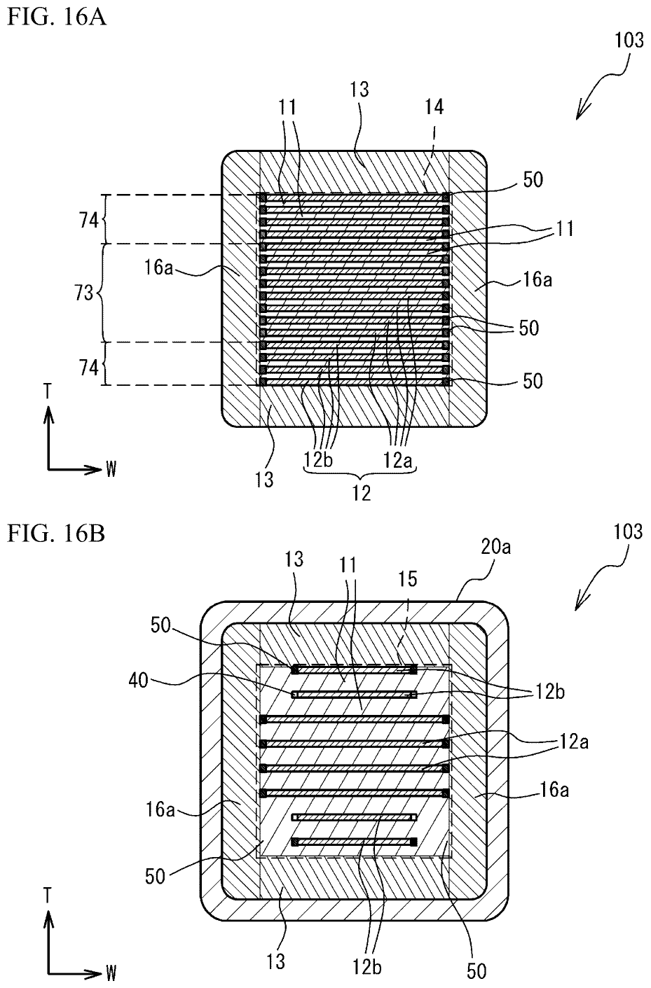

FIG. 15A and FIG. 15B are partial cross-sectional perspective views of a multilayer ceramic capacitor 103 according to a fourth embodiment. FIG. 16A and FIG. 16B are cross-sectional views of the multilayer ceramic capacitor 103. FIG. 16A and FIG. 16B illustrate cross sections at the same positions as those in FIG. 3A and FIG. 3b, respectively.

In the multilayer ceramic capacitor 103, the internal electrode layers 12 include inner internal electrode layers 12a and outer internal electrode layers 12b. The outer internal electrode layers 12b are a predetermined number of the internal electrode layers 12 from the outermost layer among the internal electrode layers 12, and the inner internal electrode layers 12a are the internal electrode layers 12 other than the outer internal electrode layers 12b among the internal electrode layers 12. The outer internal electrode layers 12b are located further outward than the inner internal electrode layers 12a in the stacking direction. A section where the dielectric layers 11 and the inner internal electrode layers 12a are stacked is defined as an inner section 73, and a section where the dielectric layers 11 and the outer internal electrode layers 12b are stacked is defined as an outer section 74.

The outer internal electrode layer 12b has the first section 121 (connection portion) that has a width W1 and is connected to the external electrode 20a in the section corresponding to the end margin 15, and the second section 122 having a width W2 in the section corresponding to the capacitance section 14, similarly to the internal electrode layers 12 according to the third embodiment. The width W1 is smaller than the width W2. In the inner internal electrode layer 12a, the width W1 in the section corresponding to the end margin 15 is equal to the width W2 in the section corresponding to the capacitance section 14.

In the fourth embodiment, as in the third embodiment, the Mg concentration in the side margin 16a is higher than the Mg concentration in the dielectric layer 11. Therefore, as illustrated in FIG. 16A, the inner internal electrode layers 12a and the outer internal electrode layers 12b in the section corresponding to the capacitance section 14 have the oxides 50 containing Ni and Mg at both ends in the W direction. This reduces or prevents the formation of the void between each end in the W direction of the internal electrode layer 12 and the corresponding side margin 16a in the section corresponding to the capacitance section 14, and thus improves the moisture resistance.

In the end margin 15, at least the uppermost and lowermost internal electrode layers 12 (outer internal electrode layers 12b) among the outer internal electrode layers 12b connected to the external electrode 20a have the oxides 50 containing Ni and Mg at the ends in the W direction because of Mg in the cover layer 13, and the ends in the W direction of other outer internal electrode layers 12b are in contact with the voids 40. In addition, due to Mg in the side margin 16a, the inner internal electrode layer 12a has the oxide 50 containing Ni and Mg at both ends in the W direction. This improves the moisture resistance, and even when outward stresses are generated in the cover layers 13 and the side margins 16a due to the expansion of the internal electrode layers 12 caused by the diffusion of the main component metal of the external electrodes 20a and 20b, the stresses can be relaxed by the voids 40, and the occurrence of cracks can be reduced or prevented.

In addition, in the multilayer ceramic capacitor 103 according to the fourth embodiment, since the inner internal electrode layer 12a has a constant width W2 in the W direction, it is possible to reduce the connection defects between the external electrode 20a and the inner internal electrode layers 12a and between the external electrode 20b and the inner internal electrode layers 12a.

The Mg concentration of the side margin 16a is, for example, 1.5 at % or greater. To facilitate the oxidation of Ni, which is the main component metal of the internal electrode layers 12, and sufficiently oxidize and expand both ends in the W direction of the internal electrode layers 12 in contact with the side margin 16a, the Mg concentration of the side margin 16a is preferably 2.0 at % or greater. On the other hand, to reduce or prevent a decrease in dielectric constant due to excessive diffusion of Mg into the dielectric layer 11, the Mg concentration of the side margin 16a is preferably 5 at % or less, and more preferably 2.5 at % or less.

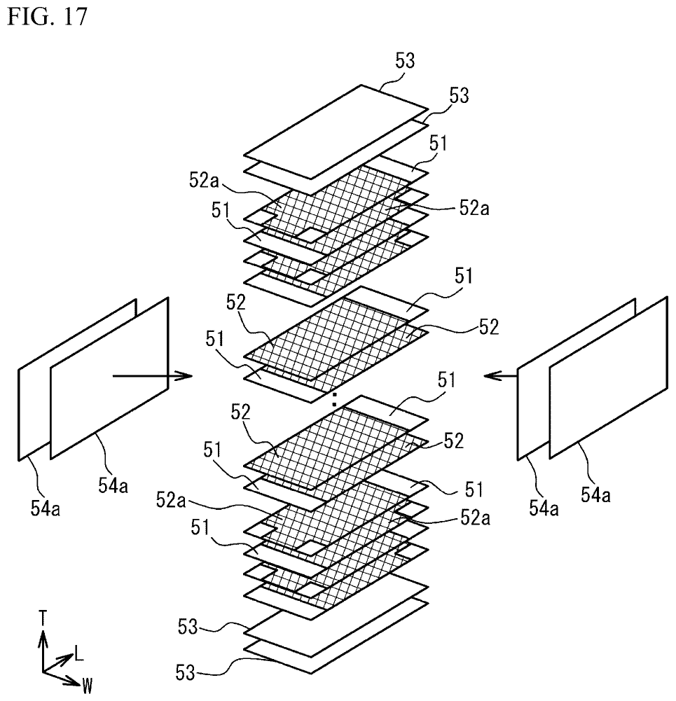

FIG. 17 illustrates an overview of a method for manufacturing the multilayer ceramic capacitor 103 according to the fourth embodiment. As illustrated in FIG. 17, in the process of manufacturing the multilayer ceramic capacitor 103, the dielectric green sheets 51 on which the internal electrode patterns 52a corresponding to the outer internal electrode layers 12b having the width W1 smaller than the width W2 are formed, respectively, are stacked, the dielectric green sheets 51 on which the internal electrode patterns 52 corresponding to the inner internal electrode layers 12a having a constant dimension in the W direction (the width W1 and the width W2 are equal) are formed, respectively, are stacked thereon, and the dielectric green sheets 51 on which the internal electrode patterns 52a are formed are stacked thereon again. Thereafter, the side margin sheets 54a having a Mg concentration higher than the Mg concentration of the dielectric green sheets 51 are attached to both side surfaces in the W direction of the multilayer body.

The Mg concentration of the side margin sheet 54a is, for example, 1.5 at % or greater. To facilitate the oxidation of Ni, which is the main component metal of the internal electrode layers 12, and sufficiently oxidize and expand both ends in the W direction of the internal electrode layers 12 in contact with the side margin sheet 54a, the Mg concentration of the side margin sheet 54a is preferably 2.0 at % or greater. On the other hand, to reduce or prevent a decrease in dielectric constant due to excessive diffusion of Mg into the dielectric layer 11, the Mg concentration in the side margin sheet 54a is preferably 5 at % or less, and more preferably 2.5 at % or less.

In the third embodiment and the fourth embodiment, the side margin 16a may be the side margin 16 having substantially the same Mg concentration as the dielectric layer 11.

In each of the above-described embodiments, a multilayer ceramic capacitor has been described as an example of a ceramic electronic component, but this does not intend to suggest any limitation. For example, the configurations of the above-described embodiments can be applied to other ceramic electronic components such as a varistor and a thermistor.

### EXAMPLES

The multilayer ceramic capacitor according to each embodiment was fabricated, and the characteristics thereof were examined.

### Example 1

In Example 1, the multilayer ceramic capacitor described in the first embodiment was fabricated. First, a slurry containing BaTiO₃ as a main component was blended and applied to obtain a dielectric green sheet. The Mg concentration of the dielectric green sheet was adjusted to be 0 at %. An internal electrode pattern was printed on each dielectric green sheet. For the internal electrode pattern, Ni powder was used, and Sn powder was added. The concentration of Sn added was 1.0 at %. The resulting multilayer units were stacked in 260 layers in the T direction to obtain a multilayer body.

A slurry containing BaTiO₃ as a main component was blended and applied to obtain a cover sheet. Mg was added to the cover sheet in an amount of 1.5 at %. A plurality of cover sheets were stacked and pressure-bonded on the top and the bottom of the above multilayer body in the stacking direction.

A slurry containing BaTiO₃ as a main component was blended and applied to obtain a side margin sheet. The Mg concentration of the side margin sheet was adjusted to be 0 at %. A plurality of side margin sheets were attached to both ends in the W direction of the multilayer body of the multilayer units, and then the binder is removed. Thereafter, the resultant was fired and re-oxidized. A metal paste containing Cu as a main component was applied to each of two end surfaces of the resulting multilayer chip, and baked at about 800° C. Then, the surface was plated with Ni and Sn. Through these steps, a multilayer ceramic capacitor having a 0603 shape (length L: 0.6 mm, width W: 0.3 mm, height T: 0.3 mm) in which 260 internal electrode layers were stacked was fabricated.

In the fired multilayer ceramic capacitor, the thickness of each internal electrode layer was 0.5 μm, and the thickness of each dielectric layer was 0.5 μm. The thickness of each cover layer in the T direction was 20 μm. The thickness of each side margin in the W direction was 20 μm. The width of each internal electrode layer in the W direction (W1=W2) was 260 μm. The dimension e by which each external electrode extends in the L direction from the corresponding end surface of the multilayer chip was 0.15 mm.

### Example 2

In Example 2, the multilayer ceramic capacitor described in the second embodiment was fabricated. First, a slurry containing BaTiO₃ as a main component was blended and applied to obtain a first dielectric green sheet. The Mg concentration in the first dielectric green sheet was adjusted to be 0 at %. An internal electrode pattern was printed on each first dielectric green sheet. For the internal electrode pattern, Ni powder was used, and Sn powder was added. The concentration of Sn added was 1.0 at %.

Next, a slurry containing BaTiO₃ as a main component was blended and applied to obtain a second dielectric green sheet. The Mg concentration in the second dielectric green sheet was adjusted to be 1.5 at %. An internal electrode pattern was printed on each second dielectric green sheet. For the internal electrode pattern, Ni powder was used, and Sn powder was added. The concentration of Sn added was 1.0 at %.

On the top of 25 multilayer units of the second dielectric green sheet, 210 multilayer units of the first dielectric green sheet were stacked, and 25 multilayer units of the second dielectric green sheet were stacked thereon to obtain a multilayer body. Other conditions were the same as those in Example 1.

### Example 3

In Example 3, the multilayer ceramic capacitor described in the third embodiment was fabricated. In each of the internal electrode layers, the width W2 in the W direction was made larger in the capacitance section, and the width W1 in the W direction was made smaller in the end margin. The width W2 of the internal electrode layer in the capacitance section was 260 μm, and the width W1 of the internal electrode layer in the end margin was 200 μm. The dimension in the L direction of the first section having the width W1 was 0.08 mm.

In addition, the Mg concentration in the side margin sheet was adjusted to be 1.5 at %. Other conditions were the same as those in Example 1.

### Example 4

In Example 4, the multilayer ceramic capacitor described in the fourth embodiment was fabricated. In each of the outer internal electrode layers, the width W2 in the W direction was made larger in the capacitance section, and the width W1 in the W direction was made smaller in the end margin. The width W2 of the outer internal electrode layer in the capacitance section was 260 μm, and the width W1 of the outer internal electrode layer in the end margin was 200 μm. The dimension in the L direction of the first section having the width W1 was 0.08 mm. The width (W1=W2) in the W direction of each inner internal electrode layer was 260 μm. Other conditions were the same as those in Example 3.

### COMPARATIVE EXAMPLE

In Comparative Example, the Mg concentration of the cover sheet was adjusted to be 0 at %, and the Mg concentration of the side margin sheet was adjusted to be 1.5 at %. Other conditions were the same as those in Example 1.

Table 1 lists the conditions of Examples 1 to 4 and Comparative Example.

TABLE 1

| | Mg concentration (at %) | | | |
|---|---|---|---|---|
| | | | Dielectric layer | |
| | Cover layer | Side margin | Inner | Outer |
| Example 1 | 1.5 | 0 | 0 | 0 |
| Example 2 | 1.5 | 0 | 0 | 1.5 |
| Example 3 | 1.5 | 1.5 | 0 | 0 |
| Example 4 | 1.5 | 1.5 | 0 | 0 |
| Comparative | 0 | 1.5 | 0 | 0 |
| example | | | | |

| | Internal electrode layer | | | | | | |
|---|---|---|---|---|---|---|---|
| | Inner | | Outer | | End | Side | Dimension |
| | W1 | W2 | W1 | W2 | margin | margin | e |
| | (μm) | (μm) | (μm) | (μm) | (μm) | (μm) | (mm) |
| Example 1 | 260 | 260 | 260 | 260 | 20 | 20 | 0.15 |
| Example 2 | 260 | 260 | 260 | 260 | 20 | 20 | 0.15 |
| Example 3 | 200 | 260 | 200 | 260 | 20 | 20 | 0.15 |
| Example 4 | 260 | 260 | 200 | 260 | 20 | 20 | 0.15 |
| Comparative | 260 | 260 | 260 | 260 | 20 | 20 | 0.15 |
| Example | | | | | | | |

For 100 samples of each of Comparative Example and Examples 1 to 4, cross sections corresponding to FIG. 3B were observed. In Comparative Example, cracks were observed in at least one corner portion in half or more of the samples. In Examples 1 to 4, no crack was observed in the corner portion in any of the samples.

The reason why no crack was observed in Examples 1 to 4 is considered to be because, in the end margin, voids were formed between the ends in the W direction of some of the internal electrode layers and the side margins or between the ends in the W direction of some of the internal electrode layers and the dielectric layers, and the stresses generated in the cover layer and the side margin were relaxed.

In addition, in Comparative Example, it is considered that since oxides containing Ni and Mg were formed at the ends in the W direction of each of the internal electrode layers and no void was formed between the internal electrode layers and the side margin, the stresses generated in the cover layer and the side margin could not be relaxed, and cracks were generated.

For each of Comparative Example and Examples 1 to 4, 100 samples were prepared and subjected to a moisture resistance reliability test. In particular, a voltage of 6.3 V was applied to each sample for 1000 hours at 85° C. and a relative humidity of 85% RH. The insulation resistance value of each sample was measured, and a sample in which the insulation resistance value after the moisture resistance reliability test was decreased by two digits or more from the insulation resistance value before the moisture resistance reliability test was determined to be rejected, and the number of rejected samples was counted.

For Comparative Examples, the number of rejected samples was 50 or more. For Examples 1 and 2, the number of rejected samples was 10 or less. For Examples 3 and 4, the number of rejected samples was zero.

The reason why the number of rejected samples was 10 or less in Examples 1 to 4 is considered to be because oxides containing Ni and Mg were formed at the ends in the W direction of one or more internal electrode layers from the outermost layer, and thus, the entry of moisture from between the side margin and the cover layer was prevented, and further, as described above, no crack occurred at the corner portion.

On the other hand, in Comparative Example, it is considered that cracks occurred in the corner portion, and thus the moisture resistance deteriorated, and half or more of the samples were rejected.

Although the embodiments of the present disclosure have been described in detail, it is to be understood that the various change, substitutions, and alterations could be made hereto without departing from the spirit and scope of the invention.

What is claimed is:

1. A ceramic electronic component comprising:
a multilayer chip having a substantially rectangular parallelepiped shape, the multiplayer chip including:
a multilayer body in which a pair of cover layers are provided on a top and a bottom of a multilayer structure in which dielectric layers and internal electrode layers are alternately stacked, the dielectric layers containing ceramic as a main component, the internal electrode layers containing Ni as a main component, the pair of cover layers containing ceramic as a main component, and
a pair of side margins covering two opposing side surfaces of the multilayer body; and
a pair of external electrodes provided on a first end surface and a second end surface of the substantially rectangular parallelepiped shape, respectively, the first end surface and the second end surface facing each other, the pair of external electrodes each including a plating layer on a base layer,
wherein the internal electrode layers are alternately exposed to the first end surface and the second end surface,
wherein each of the internal electrode layers contains a metal component having a melting point of 700° C. or less,
wherein a Mg concentration of the pair of cover layers is higher than a Mg concentration of the dielectric layers,
wherein at least an outermost internal electrode layer of the internal electrode layers has oxides containing Ni and Mg at both ends in a width direction, and
wherein at least some of the internal electrode layers are in contact with voids at both ends in the width direction in a section where internal electrode layers connected to a first external electrode of the pair of external electrodes face each other without internal electrode layers connected to a second external electrode of the pair of external electrodes interposed therebetween.

2. The ceramic electronic component according to claim 1, wherein the main component of the base layer is Cu.

3. The ceramic electronic component according to claim 1,
wherein the Mg concentration of the cover layers is 1.5 at % or greater, and
wherein the Mg concentration of the dielectric layer is 0.5 at % or less.

4. The ceramic electronic component according to claim 1, wherein the metal component contains one of the following elements: Ga, In, Sn, Bi, Pb, and Zn.

5. The ceramic electronic component according to claim 1, wherein the Mg concentration of the side margins is lower than the Mg concentration of the cover layers.

6. The ceramic electronic component according to claim 5,
wherein the Mg concentration of the cover layers is 1.5 at % or greater, and
wherein the Mg concentration of the side margins is 0.5 at % or less.

7. The ceramic electronic component according to claim 1, wherein, among the dielectric layers, a predetermined number of dielectric layers from an outermost layer has a Mg concentration higher than a Mg concentration of other dielectric layers.

8. The ceramic electronic component according to claim 7, wherein the Mg concentration of the predetermined number of dielectric layers from the outermost layer is 1.5 at % or greater.

9. The ceramic electronic component according to claim 7, wherein, among the internal electrode layers, an internal electrode layer in contact with the predetermined number of dielectric layers from the outermost layer has oxides containing Ni and Mg at both ends in the width direction.

10. The ceramic electronic component according to claim 1,
wherein each of the internal electrode layers has a connection portion connected to a corresponding external electrode of the pair of external electrodes, the connection portion having a width smaller than a width of a remaining section, and
wherein the Mg concentration of the side margins is higher than the Mg concentration of the dielectric layers.

11. The ceramic electronic component according to claim 10, wherein the Mg concentration of the side margins is 1.5 at % or greater.

12. The ceramic electronic component according to claim 10, wherein each of the internal electrode layers has oxides containing Ni and Mg at both ends in the width direction in a center in a length direction.

13. The ceramic electronic component according to claim 1,
wherein the internal electrode layers include a first number of outer internal electrode layers from an outermost layer, and an inner internal electrode layer located further inward than the outer internal electrode layers in a stacking direction,
wherein a width of a connection portion, which is connected to a corresponding external electrode of the pair of external electrodes, of each of the outer internal electrode layers is narrower than a width of a remaining section,
wherein a width of a connection portion, which is connected to a corresponding external electrode of the pair of external electrodes, of the inner internal electrode layer is substantially equal to a width of a remaining section;
wherein the Mg concentration of the side margins is higher than the Mg concentration of the dielectric layers.

14. The ceramic electronic component according to claim 13, wherein the Mg concentration of the side margins is 1.5 at % or greater.

15. The ceramic electronic component according to claim 13, wherein each of the outer internal electrode layers and the inner internal electrode layer has oxides containing Ni and Mg at both ends in the width direction in a center in a length direction.

16. A method for manufacturing a ceramic electronic component, the method comprising:
obtaining a first multilayer body in which multilayer units are stacked, each of the multilayer units including a dielectric green sheet and an internal electrode pattern formed on the dielectric green sheet, the internal electrode pattern containing Ni as a main component, a metal component having a melting point of 700° C. or less being added to the internal electrode pattern;
obtaining a second multilayer body in which cover sheets are stacked on a top and a bottom of the first multilayer body in a stacking direction of the multilayer units, respectively, the cover sheets having a Mg concentration higher than a Mg concentration of the dielectric green sheet;
obtaining a third multilayer body to which side margin sheets are attached, the side margin sheets covering a first side surface and a second side surface of the second multilayer body, respectively, the internal electrode pattern being exposed to the first side surface and the second side surface; and
forming a base layer on each of a first end surface and a second end surface, which face each other, of the third multilayer body when the third multilayer body is fired or after the third multilayer body is fired, the base layer containing a metal as a main component.
